(19) United States
(12) Patent Application Publication
(10) Pub. No.: US 2016/0240210 A1
(43) Pub. Date: Aug. 18, 2016

(54) Speech Enhancement to Improve Speech Intelligibility and Automatic Speech Recognition

(71) Applicant: Xia Lou, Los Altos, CA (US)

(72) Inventor: Xia Lou, Los Altos, CA (US)

(21) Appl. No.: 15/047,584

(22) Filed: Feb. 18, 2016

Related U.S. Application Data
(63) Continuation-in-part of application No. 13/947,079, filed on Jul. 21, 2013, now abandoned.
(60) Provisional application No. 61/674,361, filed on Jul. 22, 2012.

(51) Int. Cl. G10L 21/02; G10L 21/0388; G10L 25/15; G10L 21/0232

(52) U.S. Cl. CPC G10L 21/0205; G10L 21/0232; G10L 21/0388; G10L 25/15; G10L 2021/02166

(57) ABSTRACT

Systems and methods are provided for enhancing speech signal intelligibility and for bettering performance of automatic speech recognition processes, for a speech signal in a noisy environment. Some typical application environments include a media device such as a smart TV. An acoustically coupled loudspeaker signal and signals from one or more microphones can be employed to enhance a near end user speech signal. Some processing can be application-specific, such as specific to applications wherein cleaned speech is employed for human voice communication and/or specific to applications employing Automatic Speech Recognition (ASR) processing. A formant emphasis filter and a spectrum band reconstruction process can be employed to enhance speech quality and/or to improve ASR recognition rate performance. A speech signal can be characterized and the characterization can be employed to improve ASR performance. Some systems and methods apply to devices having a foreground microphone and a background microphone.

### CLAIM OF PRIORITY

This application is a continuation-in-part of prior-filed and co-pending application Ser. No. 13/947,079, filed Jul. 21, 2013 which claims the benefit of priority under 35 U.S.C. 119(e) to U.S. Provisional Patent Application No. 61/647,361 (now abandoned) filed on Jul. 22, 2012 entitled “SPEECH ENHANCEMENT TO IMPROVE SPEECH INTELLIGIBILITY AND AUTOMATIC SPEECH RECOGNITION,” the entirety of each of which is hereby incorporated herein by reference.

### TECHNICAL FIELD

The present invention relates to systems and methods for enhancement of speech signals, and, for improved performance of an Automatic Speech Recognizer (ASR).

### BACKGROUND

In everyday living environments, audible and/or acoustical noise is ubiquitous. Such noise is a challenge to speech quality in mobile communications and Voice Over IP (VOIP) applications, and can severely decrease accuracy of Automatic Speech Recognition processes. Notable examples relate to a digital living room environment. Connected devices such as smart TVs and/or other smart appliances are being widely adopted by increasing numbers of consumers. Thus the digital living room is evolving into a new digital hub, where Voice Over Internet Protocol communications, social gaming, and voice interactions over smart TVs can be central activities. In these situations, microphones can typically be found located near to, or conveniently integrated into, a smart TV. Users typically sit at a comfortable viewing distance in front of the TV. The microphones receive users' speech, but also disadvantageously pick up noise in the form of unwanted sound directly from the TV's loudspeakers, and reverberant sound energy caused by the TV loudspeakers. Due to the proximity of the microphone(s) to the TV loudspeakers, a user's speech can be overpowered by undesirable sound energy generated by the TV speakers. This can negatively affect speech quality for applications utilizing speech signals, such as VOIP applications. In some situations, such as Talk Over Media (TOM) applications, a user may prefer to use voice to control and/or search media content. However, voice control can be problematic if attempted at the same time as the TV is providing sound output such as media program content. A high level of unwanted TV sound output combined with the user speech can significantly lower the quality of the user speech signal. Such a significantly degraded user speech signal can cause Automatic Speech Recognition functions to perform poorly.

Some speech enhancement techniques have been developed to improve speech clarity and intelligibility in noisy environments. Microphone array beamformers have been used to focus and enhance speech from the direction of a talker. Such a beamformer can act as a spatial filter. Acoustic Echo Cancellation (AEC) is another technique that has been employed in order to filter out unwanted far end echoic energy. When a signal produced by TV speaker(s) is known, it can be treated as a far end reference signal. However, there are several problems with prior art speech enhancement techniques. Many such prior art techniques are designed principally for near field applications in which microphones are located relatively near to the talker, such as as typical for mobile phones and Bluetooth headsets. In such near field applications, the Signal to Noise Ratio (SNR) may be high enough for such speech enhancement techniques to be effective in suppressing and removing the interfering noise and echo.

However, in typical far field applications, microphones can be 10 to 20 feet distant from the talker. In such situations, the microphone-received signal quality, which can be parameterized by SNR, can be very low. Thus the known techniques typically have poor performance in far field applications. Signal results produced by traditional methods can have large amounts of noise and echo remaining and/or introduce high levels of distortion to the speech signal; these effects severely decrease speech intelligibility.

Prior art techniques also fail to distinguish applications utilizing user speech such as VOIP applications, from applications dependent upon ASR performance. Processed outputs which are intelligible to a human may not provide for optimal performance of an ASR.

Another shortcoming of prior art techniques of speech enhancement can be power inefficiency. In some prior art techniques, adaptive filters are employed in an attempt to null the acoustic coupling between loudspeakers and microphones. However, large numbers of filter taps are required to reduce reverberant echo. The adaptive filters used in prior art can be slow to adapt adequately towards an optimal solution, and can require significant processing power, memory space, and/or other resources associated with implementing filters with relatively large numbers of taps.

Thus there is a need to provide improved capabilities over many shortcomings of prior art techniques.

### SUMMARY

Systems and methods for characterizing and enhancing a speech signal are illustrated and described herein. Application embodiments include those suitable for a digital living room environment comprising a media device such as a smart TV. An enhancement process can provide a cleaned speech signal, responsive to a media reference signal and a microphone signal. An enhanced speech signal can be provided, responsive to the cleaned speech signal. Systems and methods can provide characterization of user speech, and such characterizations can comprise acoustic features and/or processing profiles.

An automatic speech recognizer (ASR) can attain improved performance by utilizing characterizations provided by the enhancement process. A media device can receive ASR output such as recognized words, and utilize such words for control of media device functions and/or other interactions with applications corresponding to the media device.

### BRIEF DESCRIPTION OF THE DRAWINGS

FIG. 1 depicts a system embodiment for characterizing and enhancing a speech signal.

FIG. 2 depicts an improved application embodiment.

FIG. 3 depicts a speech enhancement processing method.

FIG. 4 depicts detailed embodiments for characterizing and enhancing a speech signal.

FIG. 5A depicts embodiments of a microphone array and beamforming function.

FIG. 5B depicts embodiments of a microphone array and beamforming function.

FIG. 6 depicts embodiments of time-domain to frequency-band transformation.

FIG. 7 depicts embodiments of an adaptive estimation filter.

FIG. 8 depicts embodiments of a noise transformation process.

FIG. 9 depicts embodiments of a noise reduction function.

FIG. 10 depicts embodiments of a formant emphasis filter.

FIG. 11 depicts embodiments of performance enhancements for an automatic speech recognizer.

FIG. 12 depicts an embodiment of an exemplary phone application.

FIG. 13 depicts a computer system.

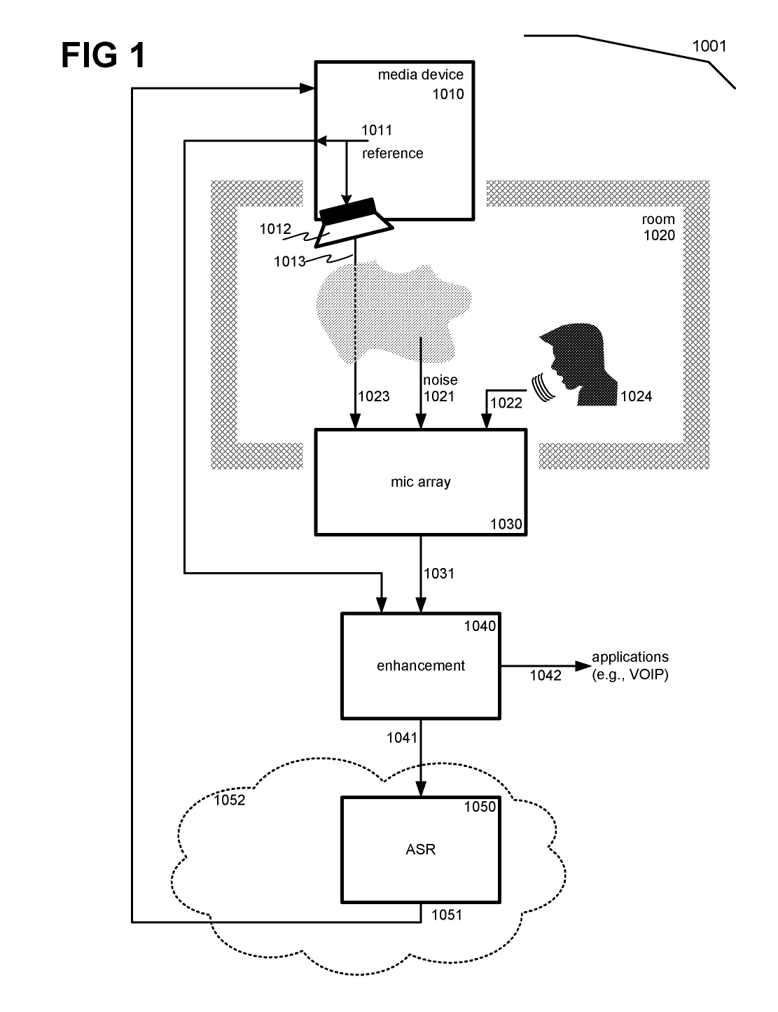

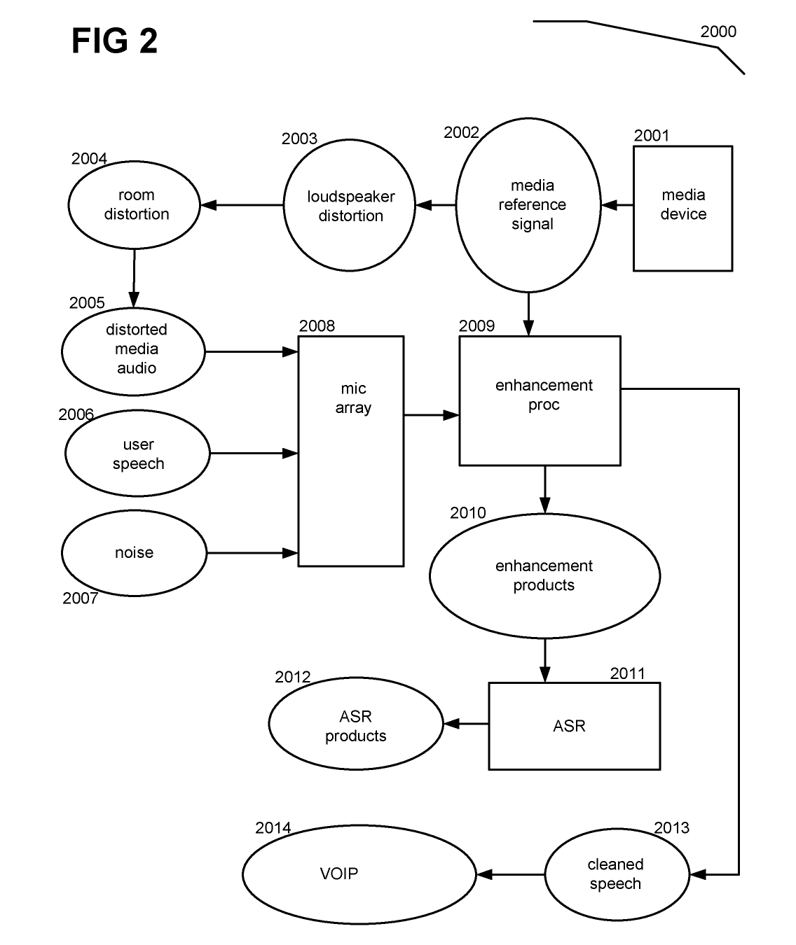

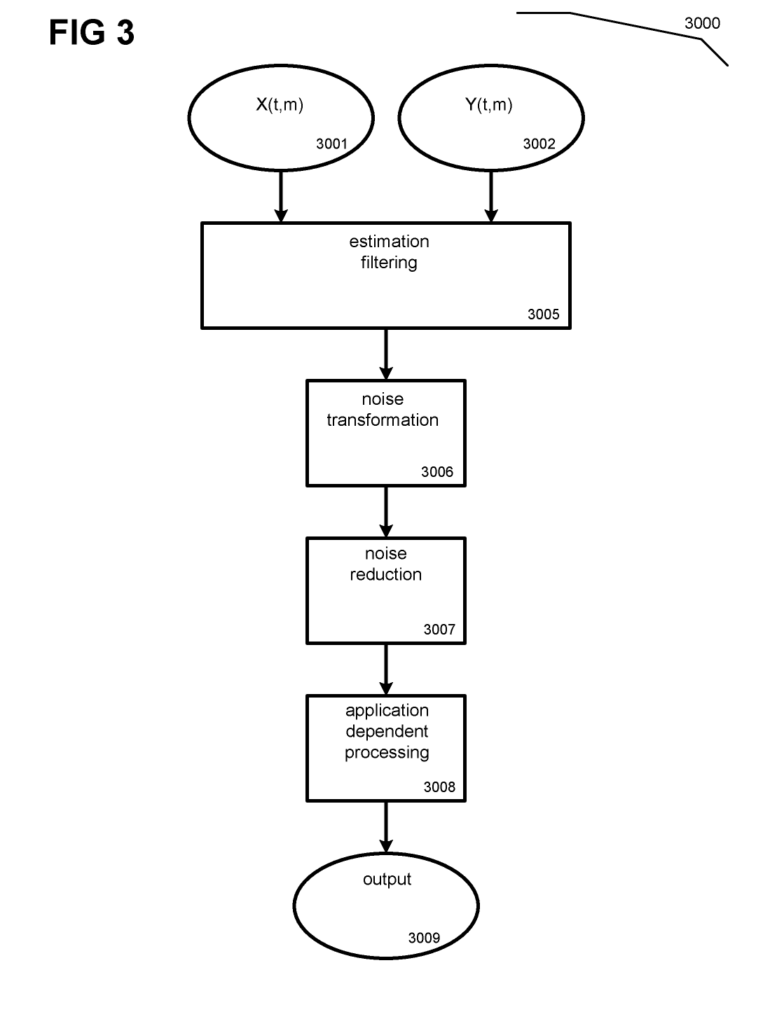

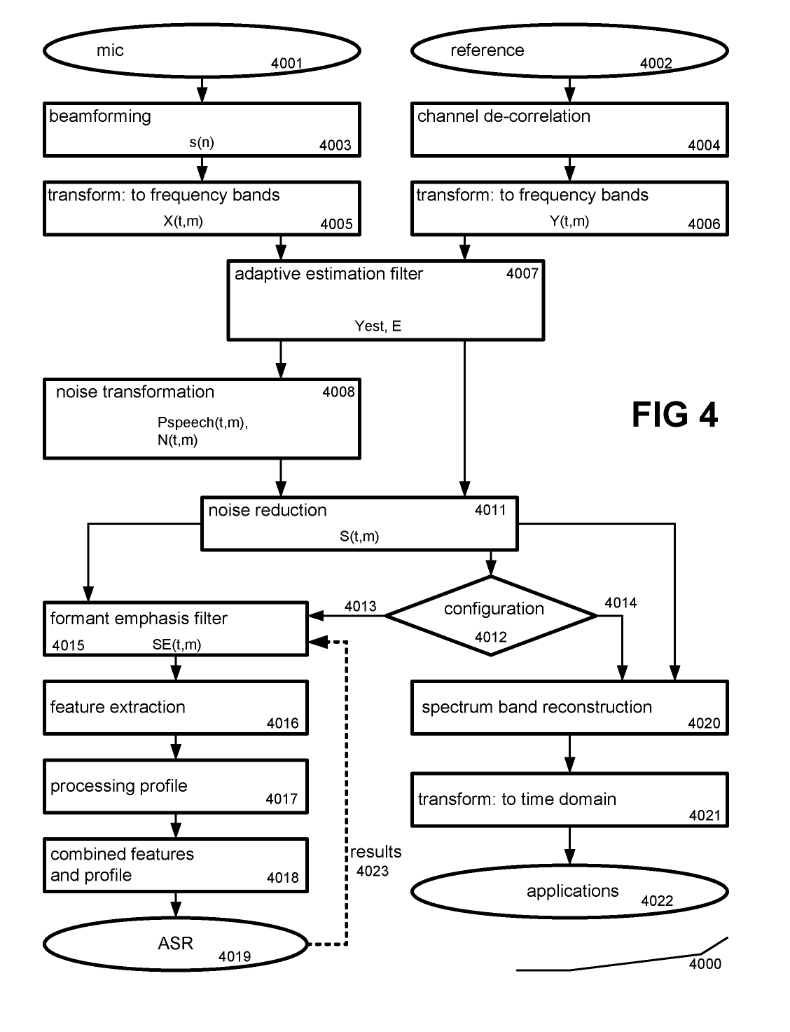

### DETAILED DESCRIPTION

Diagram 1001 depicts an embodiment of a system for characterizing and enhancing a speech signal, applied to a room environment 1020 such as a living room environment. A user 1024 within the room 1020 can interact with a media device 1010 such as a smart TV. Some user applications, by way of non-limiting examples, can comprise user voice control of the media device 1010 and user voice communications such as telephony, utilizing VOIP. Quality of performance of these applications can vary with the quality of the user speech signal. As the SNR and other qualities of the user speech signal varies so can accuracy in control applications, and/or speech intelligibility in voice communications. Thus enhanced quality of a speech signal can be advantageous. Accuracy in control applications can be dependent upon performance accuracy of automatic speech recognizer ASR 1050. Thus providing characterization of the speech signal to thereby improve ASR performance can be advantageous.

Mic array 1030 can comprise one or more microphones for acoustically receiving user speech 1022 and responsively providing a user speech signal. Such a user speech signal can be degraded by contributions of acoustical effects and events within the room 1020.

The room can comprise sources of background noise 1021 that are received by the microphone(s). One or more acoustically coupled loudspeaker signals 1023 can be acoustically sourced 1013 by loudspeakers 1012 of the media device 1010. The acoustically sourced media audio 1013 can undergo distortion such as room effects, thus the contribution 1023 received by microphone(s) can be alternatively described as distorted media audio.

Increased distance between user 1024 and the microphone(s) can lower SNR and/or other quality measures of the received user speech. In some embodiments, placement of microphones within a media device 1010 such as a smart TV device can select for increased distance in typical applications. In some embodiments enhancement function 1040 can provide beamforming processing to enhance spatial and/or other selectivity of the microphone signal(s).

The acoustically coupled loudspeaker signal(s) 1013 correspond to a media reference signal 1011. This reference signal is provided to enhancement function 1040. Enhancement processing can employ the media reference 1011 to separate user speech from the distorted media audio, thereby providing a cleaned speech signal. Such a cleaned speech signal can be advantageously provided to applications 1042. Applications 1042 can comprise user voice applications such as telephony, which can utilize VOIP.

Enhancement function 1040 can provide characterization of embodiments of the user speech, and of cleaned speech signals. Such speech signals and/or characterizations 1041 can be provided to Automatic Speech Recognizer ASR 1050. ASR 1050 can advantageously employ such signals and/or characterizations to provide increased recognition accuracy and/or other performance features. Such signals and/or characterizations can comprise acoustic features such as Mel-frequency cepstrum coefficients, and/or corresponding statistics such as speech probability, and/or profiles.

ASR output 1051 can comprise recognized words. In some application embodiments, ASR output 1051 words can be fed back to media device 1010 in order to control the media device.

In some embodiments, interactions such as communications amongst elements of the depicted system 1001 and/or other systems can utilize networks and/or networks of networks such as an internet 1052. In some embodiments, elements of the system can be physically remote from each other. By way of example, an ASR function 1050 could be located remotely to the other elements and could be coupled with other elements by way of an internet 1052.

Smart TV services can integrate traditional TV capabilities, such as cable TV offerings, with internet functionality. In earlier technologies, such internet functionality could be provided by a separate computer, such as a personal computer. Diagram 2000 depicts a smart TV talk over media (TOM) improved application embodiment. In some such application embodiments, a user can browse the internet, watch streaming videos, and/or place VOIP calls on their media device, such as a big screen TV device. A large display format combined with high definition can make such a TV media device advantageous for user participation in internet gaming and/or video chat. A smart TV can function as an infotainment hub for a digital living room environment. In some embodiments a traditional remote control, lacking voice control, can provide inadequate control performance for some complicated user menu systems. For some embodiments, voice control can be advantageous and highly desirable. Voice control alone and/or in combination with traditional remote control techniques can provide advantageously natural, convenient, and/or efficient interactions between a user and media device functionality and applications.

In a case where the microphone(s) are integrated into and/or placed near a TV media device, VOIP call quality can be adversely affected by a relatively large distance separating a speaking user and the microphone(s). Such distances can degrade acoustical signals, thus notably decreasing SNR levels for received speech. Such degradation can render an automated speech recognition (ASR) function ineffective. This problem can be exacerbated under the condition that audio provided by the media device is simultaneously played through the loudspeakers.

Diagram 2000 depicts such a living room environment. A signal received by the microphone or microphone array 2008 can largely comprise a user speech signal 2006, distorted media audio 2005 (also known as an acoustically coupled speaker signal) and background noise 2007. The media reference signal 2002 can experience distortion as it is transformed by loudspeaker(s) and room acoustics on its way to being received as ‘distorted media audio’ signal 2005 at the microphone array 2008. In some embodiments, these distortions can be primarily attributed to the acoustical characteristics of the room, and, limitations of the loudspeaker system. Such acoustical characteristics can be described as room distortion 2004. Such limitations of the loudspeaker system can be described as loudspeaker distortion 2003. In some embodiments, such acoustical characteristics of a room can be specified and/or described by a room impulse response. In some embodiments, such limitations of a loudspeaker system can be specified and/or described by a loudspeaker system frequency response.

In order to separate a user speech signal 2006 from distorted media audio 2005, media reference signal 2002 can be utilized as a noise reference by a speech enhancement processor 2009. The processor 2009 can obtain a cleaned speech signal 2013 by separating the media reference signal 2002 from the combination of signals received by microphone array 2008. The cleaned speech signal 2013 can be provided to functions such as compression and/or for transmission over VOIP channels 2014.

Enhancement processing 2009 can also provide enhancement products 2010 suitable for use by an automatic speech recognition (ASR) function 2011. These products can comprise elements that characterize and/or otherwise describe the cleaned speech 2013 signal and/or other signals and/or measures within enhancement processor 2009.

Such products can comprise a set of acoustic features. An acoustic feature set can comprise Mel-frequency cepstrum coefficients (MFCC) and/or related characterizations of the speech and/or cleaned speech signals. A set can comprise Perceptual Linear Prediction (PLP) coefficients and/or any other known and/or convenient features. A set of processing profiles and statistics that can act as priory information can also be provided and combined with acoustic features. Such a combination can be utilized by ASR 2012. By way of non-limiting example, an ASR 2012 can advantageously employ such sets and/or combinations to enable operation of an acoustic feature pattern matching engine within ASR 2012.

Diagram 3000 depicts a speech enhancement processing method that can be suitable for a variety of applications, such as those of diagrams 1000 and 2000 as illustrated and depicted herein. The method comprises a multi-stage approach to remove unwanted TV sound and background noise from a microphone signal X(t,m) 3001.

In a living room environment, a microphone signal can contain user speech, a distorted loudspeaker signal, and background noise. Acoustical energy transmission within the room can comprise a plurality of acoustical paths. Some such paths can be characterized as corresponding to early reflections, and some such paths can be characterized as corresponding to late reflections. Thus, a distorted loudspeaker signal can be represented by a summation of early reflections and late reflections originating with a source loudspeaker signal.

Employing a media reference signal corresponding to an undistorted loudspeaker signal Y(t,m) 3002, an estimation filtering step 3005 can be employed to remove the early reflections. Estimation filtering step 3005 can correspond to adaptive estimation filter embodiments 4007 7000 as illustrated and described herein. In some typical embodiments, early reflection time in a room can approximately range from 50 milliseconds to 80 milliseconds. Thus an effective estimation filter need only estimate the first 80 milliseconds of the room impulse response and/or room transfer function. This provides for a relatively low number of required filter taps in the estimation filter. Such a low number of filter taps can enable the filter to converge faster to an optimum solution in an initial phase. Such a low number of filter taps can also provide for a filter that can be relatively stable under perturbations due to changes in acoustic paths.

Some prior art embodiments use traditional acoustic echo cancellation techniques and can thus require much larger filters to adapt to a full length of a room impulse response. In some typical embodiments such a full length can exceed 200 milliseconds. The relatively large number of filter taps required for a corresponding adaptive filter can disadvantageously lead to increased computation, memory, and power requirements.

Estimation filter outputs can be used by noise transformation step 3006 to produce an estimated late reflections signal, which can be used as a noise reference signal. Such a noise reference signal can closely resemble late reflections of the distorted speaker signal. Noise transformation step 3006 can correspond to noise transformation embodiments 4008 8000 as illustrated and described herein.

The noise reference signal can be used by a noise reduction step 3007 to further remove reverberant late reflections and/or background noise. Noise reduction step 3007 can correspond to noise reduction embodiments 4011 9000 as illustrated and described herein.

In step 3008, various additional processing methods can be selectively applied, with outputs 3009 resulting. The selection of processing methods can be responsive to intended use of the processed signal(s). In some embodiments, a first set of specific outputs can be developed suitable for use by an automatic speech recognizer. In some embodiments, a second set of specific outputs can be developed suitable for use by VOIP and/or other applications. In some embodiments, the processing for the first and second sets can be selected in the alternative. In some embodiments, processing for the first and second sets can be selected in combination.

Diagram 4000 illustrates detailed embodiments of speech enhancement and characterization processing corresponding to enhancement function 1040. In an embodiment, such processing can enhance speech quality and improve performance, such as detection rate, of an Automatic Speech Recognizer.

In an embodiment, a microphone array 4001 1030 can comprise two omnidirectional microphones. Various quantities of microphones having various geometric placements can be employed in other embodiments.

Beamforming processing 4003 5501 can be employed to localize and enhance a near end user speech signal in the direction of a talker. In one embodiment, Minimum Variance Distortionless Response (MVDR) beamforming can be used to generate a single microphone beamforming output signal. In another embodiment, Linearly Constrained Minimum Variance beamforming techniques can be employed. In yet another embodiment, the position of the talker can be known, and a set of weighting coefficients can be pre-calculated to steer the array to the known talker's position. In such a case, a beamformer output can be obtained as the weighted sum of all the microphone signals in the array.

A loudspeaker signal such as depicted herein as media reference signal 4002 1011 can be in a stereo format. In some typical embodiments, a media device 1010 such as a smart TV can provide such a signal. There can be a high degree of correlation between left and right channels in such signals. Such inter-channel correlation can inhibit an estimation filter from converging on a true optimum solution. In an embodiment, a channel de-correlation function 4004 can be advantageously employed in order to facilitate such optimization. In one embodiment, de-correlation can be achieved by adding inaudible noise to both channels. In another embodiment, a half wave rectifier can be used to de-correlate the left and right channels. In another embodiment the position of the talker can be known, and, pre-calculated microphone array beamforming weighting coefficients can be applied as channel mixing weight coefficients, thereby forming a single channel output from the de-correlation function 4004.

Processing systems and methods described herein can be embodied in time domain or frequency domain implementations. In some embodiments, specific signal processing functions implemented in the frequency domain can be generally more efficient than such processing implemented in the time domain. In a frequency domain implementation, a microphone signal and the speaker signal can be transformed into frequency coefficients or frequency bands as depicted by transforming functions 4005 4006. Such transforming functions are further illustrated and described in diagram 6000. In some embodiments, filter banks such as Quadrature Mirror Filter (QMF) and Modified Discrete Cosine Transform (MDCT) can be used to implement a time domain to frequency domain transformation. In an embodiment, time domain to frequency domain transformation can employ a short time Fast Fourier Transform (FFT).

An adaptive estimation filter function 4007 7000 can be employed to estimate and remove early reflections of a loudspeaker signal. In one embodiment, an adaptive estimation filter can be implemented as a FIR filter with fixed filter coefficients. Such fixed filter coefficients can be derived from the measurements of a room. In another embodiment, an adaptive filter can be used to estimate early reflections of a loudspeaker signal.

Output 7007 of the filter can comprise a user speech signal comprising some residual noise. Such a residual noise component can be caused largely by late reflections of the loudspeaker signal.

A noise transformation function 4008 8000 can utilize estimated early reflections of the loudspeaker signal that are provided by the estimation filter 4007 7000, in order to derive a representation of the late reflections of the loudspeaker signal. A performance goal can be to generate a noise reference that is statistically similar to a noise component that remains in the estimation filter output. The noise transformation function can also provide a speech probability measure Pspeech(t, m) that represents the relative amount of near end user speech signal present in the estimated early reflections signal, where t represents the t^{th} frame and m represents the m^{th} frequency band.

A noise reduction function 4011 9000 can be employed to further reduce late reflection components from the speech bands.

A configuration function 4012 can control processing in two branches 4013 4014 according to a system configuration state. One or both branches can be processed, according to the configuration state. Processing branch 4014 can serve to improve speech quality for a human listener. Processing branch 4013 can serve to improve performance, such as recognition rate, of an ASR 4019 1050.

In operating to adequately suppress noise, noise reduction function 4011 may remove a significant amount of low frequency content from a speech signal. Such a speech signal can be perceived as sounding undesirably thin and unnatural, as the bass components are lost. In the speech enhancement branch 4014, spectrum content analysis can be performed and lower frequency bands can be advantageously reconstructed within spectrum band reconstruction function 4020. In an embodiment, Blind Bandwidth Extension can be used to reconstruct the lower frequency bands, that is, bass, portions of the speech spectrum. Embodiments for Blind Bandwidth Extension are disclosed in: Litjeryd, et al. SOURCE CODING ENHANCEMENT USING SPECTRAL-BAND REPLICATION. U.S. Pat. No. 6,925,116 B2 issued Aug. 2, 2005, the complete contents of which are hereby incorporated by reference.

In another embodiment, the Pspeech(t, m) provided by noise transformation function 4008 can be compared to a threshold to generate a binary decision. An exemplary value for a threshold can be 0.5. The binary decision result can be employed to determine whether to reconstruct each of the t^{th} frame and the m^{th} frequency band.

In yet another embodiment, the reconstructed low frequency bands according to Blind Bandwidth Extension can be multiplied with the corresponding Pspeech(t, m) to generate a further set of reconstructed speech bands. This further set of reconstructed speech bands can be transformed to time domain signals. Such a transformation is depicted as “transform: to time domain” function 4021. Such signals can be suitable for voice applications 4022 1042, such as telephony, that can employ VOIP channels. In one exemplary embodiment, a transformation from frequency domain to time domain can be implemented using Inverse Fast Fourier Transform (IFFT). In other embodiments, filter bank reconstruction techniques can be utilized.

In processing branch 4013, a formant emphasis filter 4015 10000 can be employed to emphasize spectrum peaks of cleaned speech while maintaining the spectrum integrity of the signal. Such embodiments can improve ASR performance measures such as Word Error Rate (WER) and confidence score, for ASR 4019 1050 11000.

Within feature extraction function 4016, acoustic features such as MFCC and/or PLP coefficients can be extracted from the emphasized speech spectrum. Within processing profile function 4017, a processing profile can be developed from the emphasized speech spectrum. Such a processing profile can comprise a speech activity indicator and a speech probability indicator for each frequency band. A processing profile can be coded as side information. A processing profile can also contain statistical information such as the mean, variance and/or derivatives of a spectrogram of a cleaned and/or emphasized speech signal. Characterizations of the speech signal comprising combinations of acoustic features and profile 4018 can be provided to an ASR, thereby enabling better acoustic feature matching results by the ASR. ASR results 4023 can comprise matched results and confidence scores. In some embodiments, such results 4023 can be provided by an ASR and fed back to formant emphasis filter 4015. In some embodiments, a formant emphasis filter 4015 can employ such results to refine the formant emphasis filtering process.

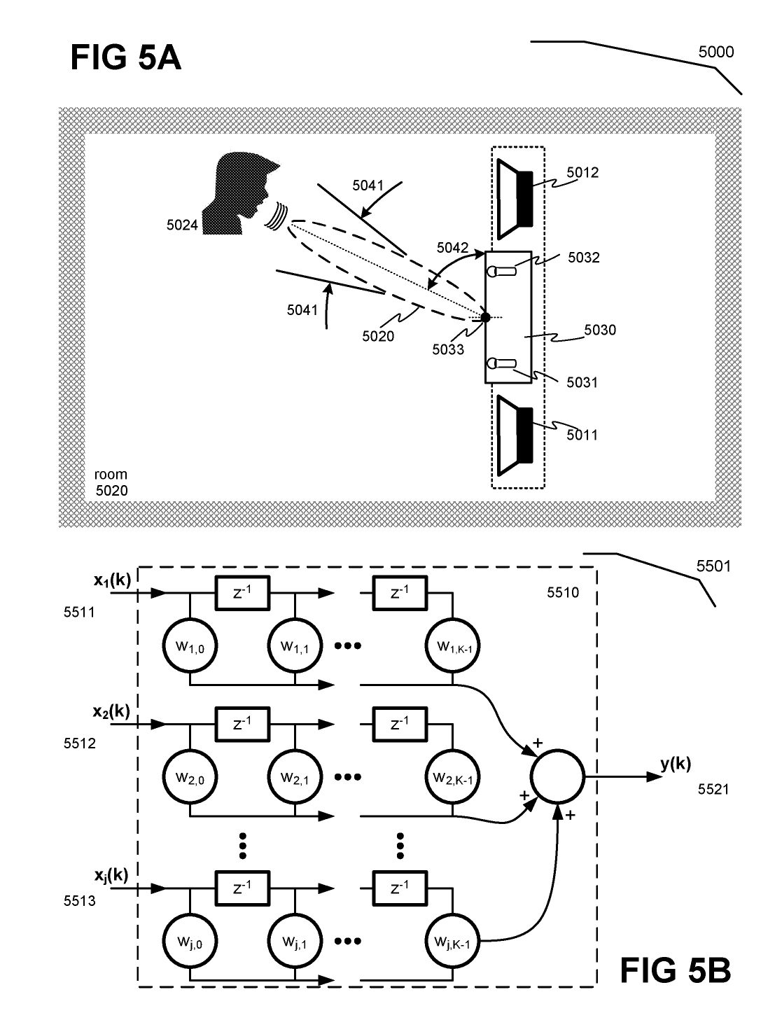

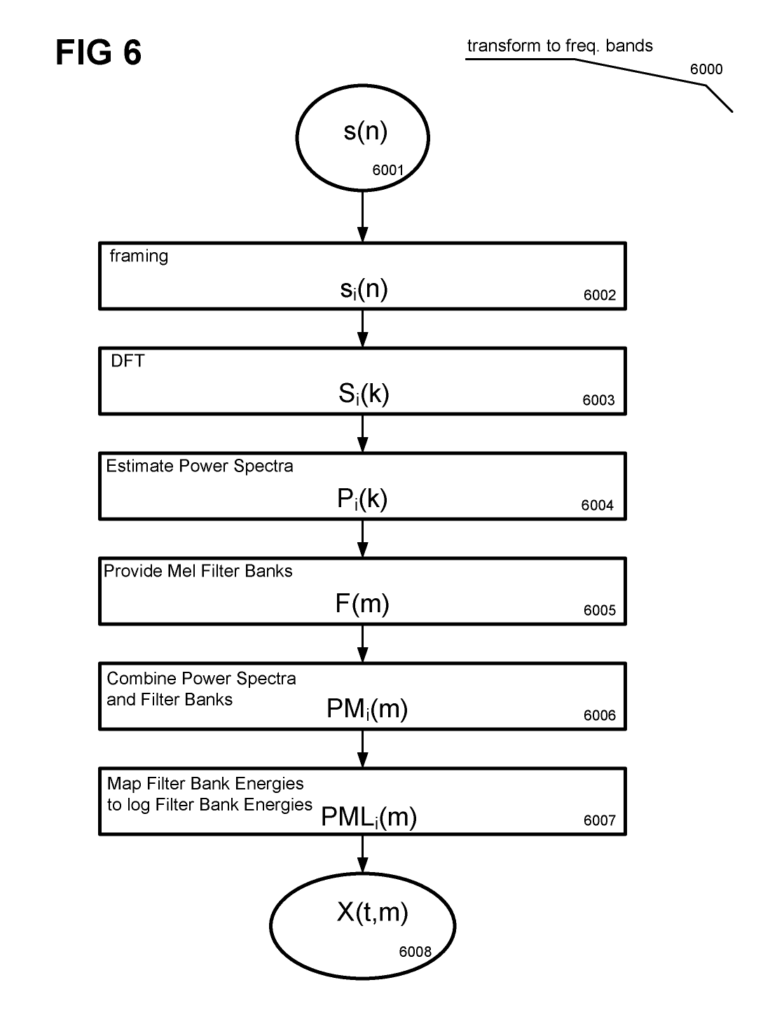

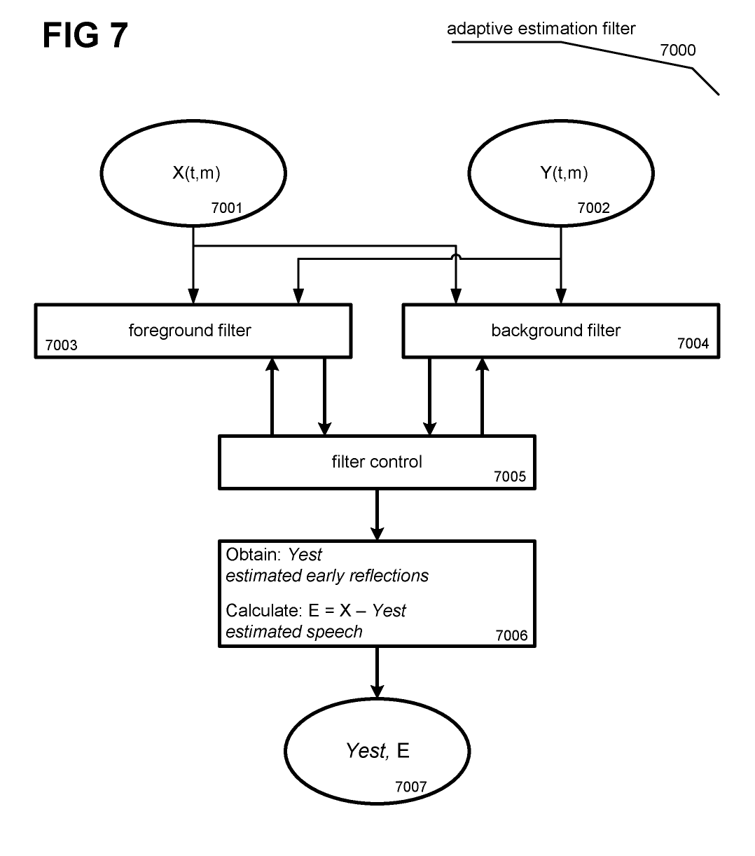

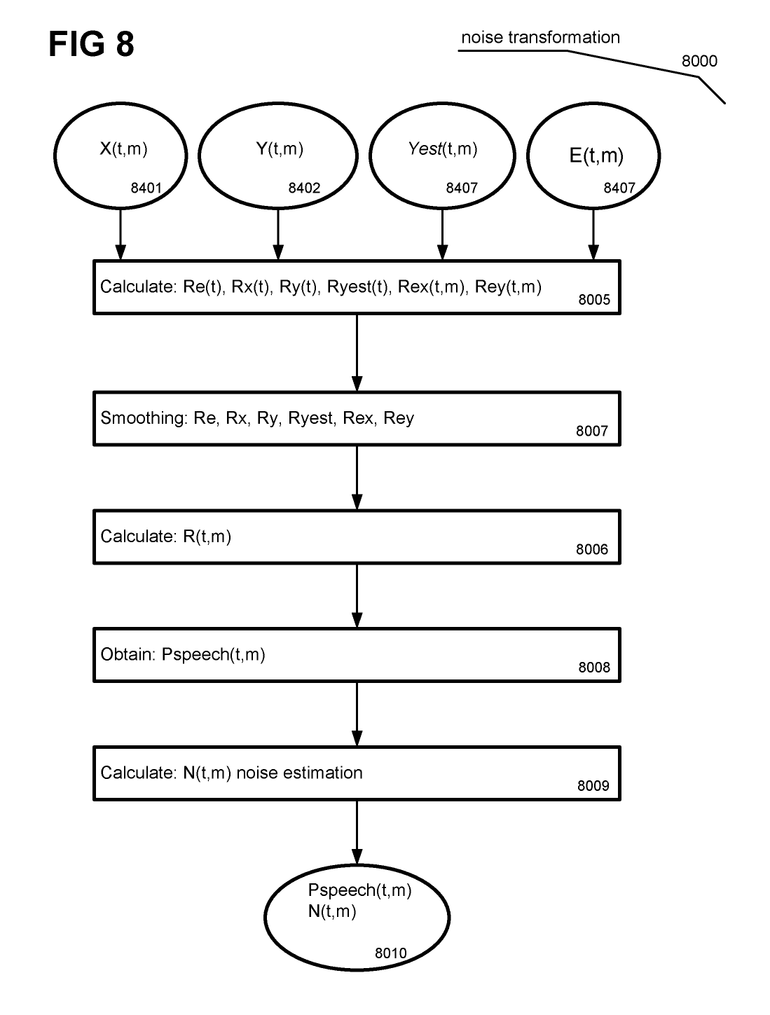

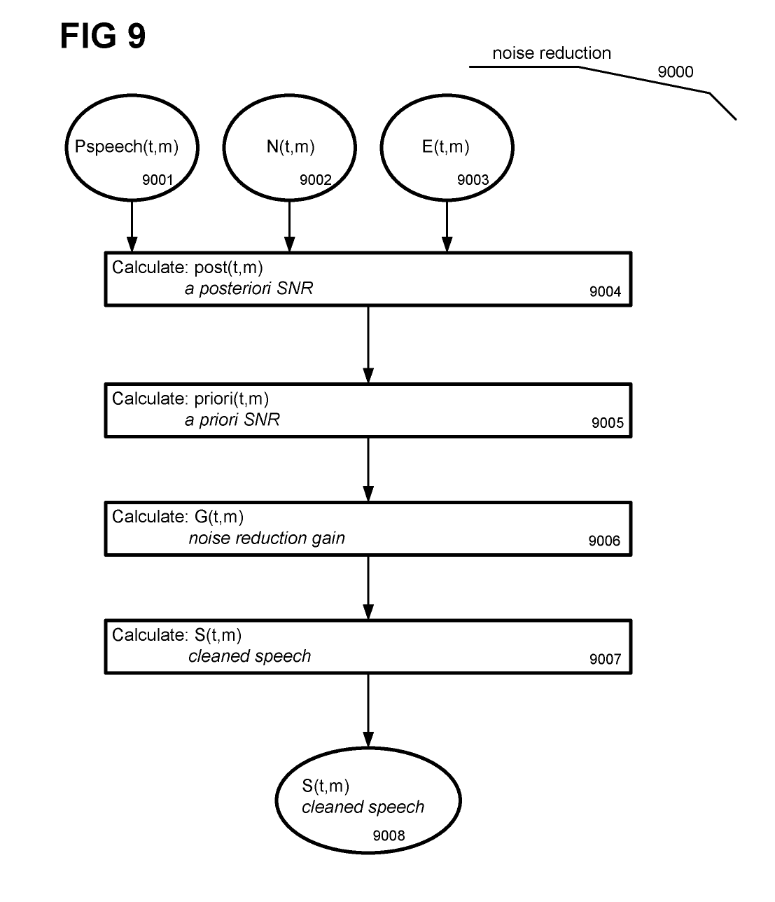

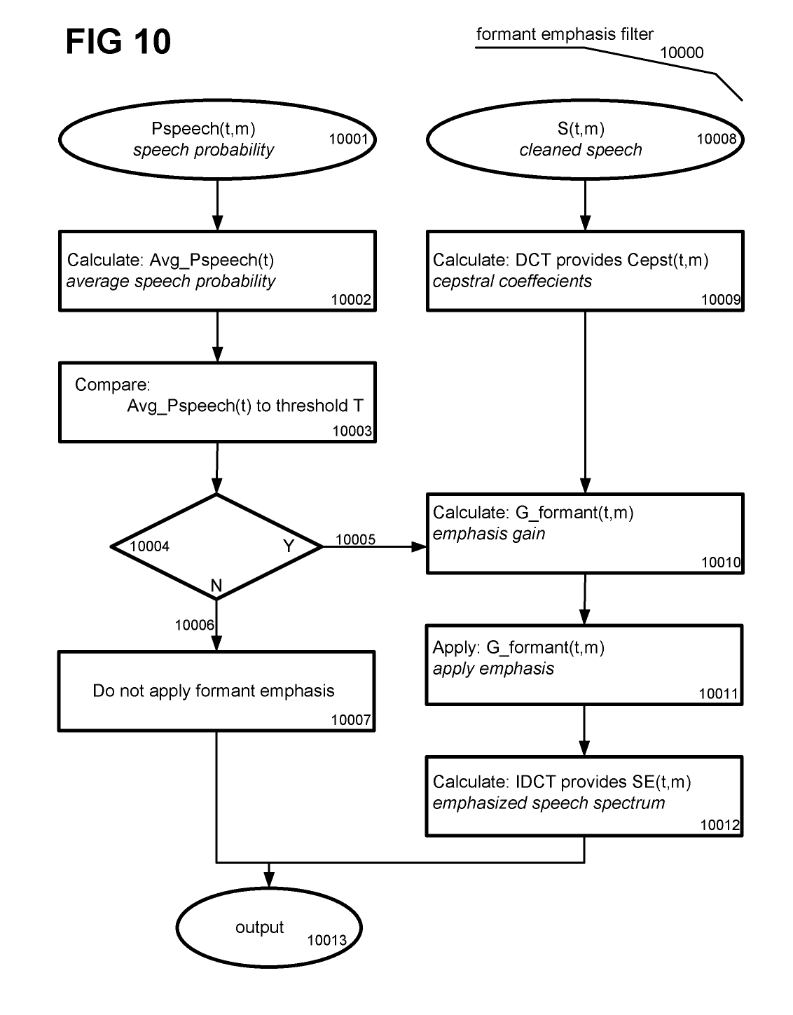

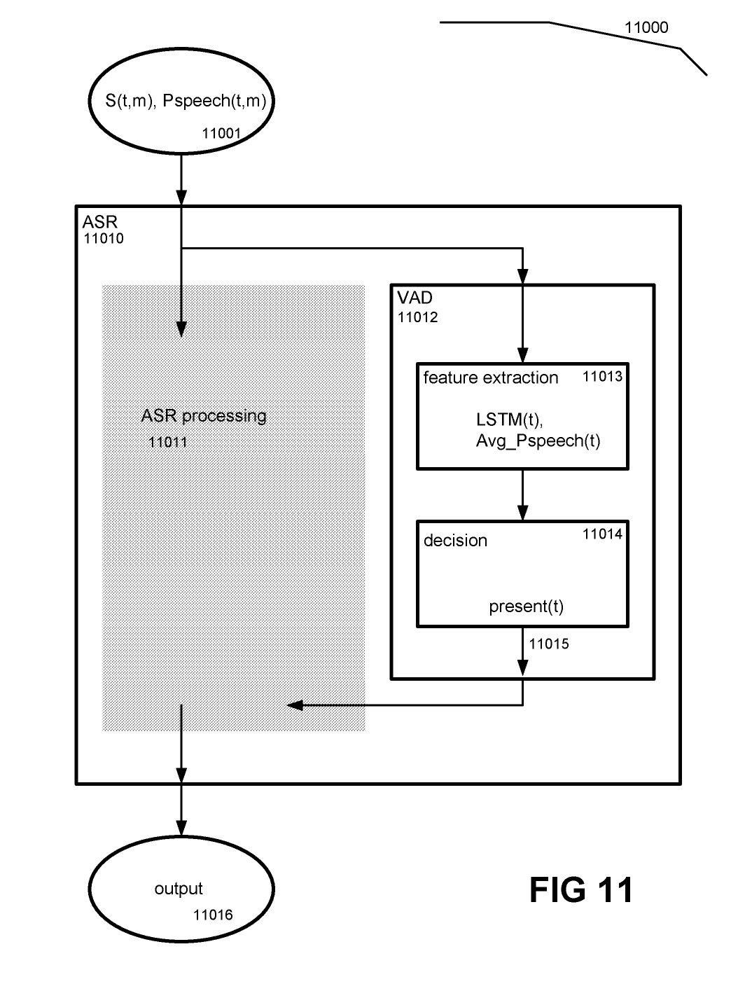

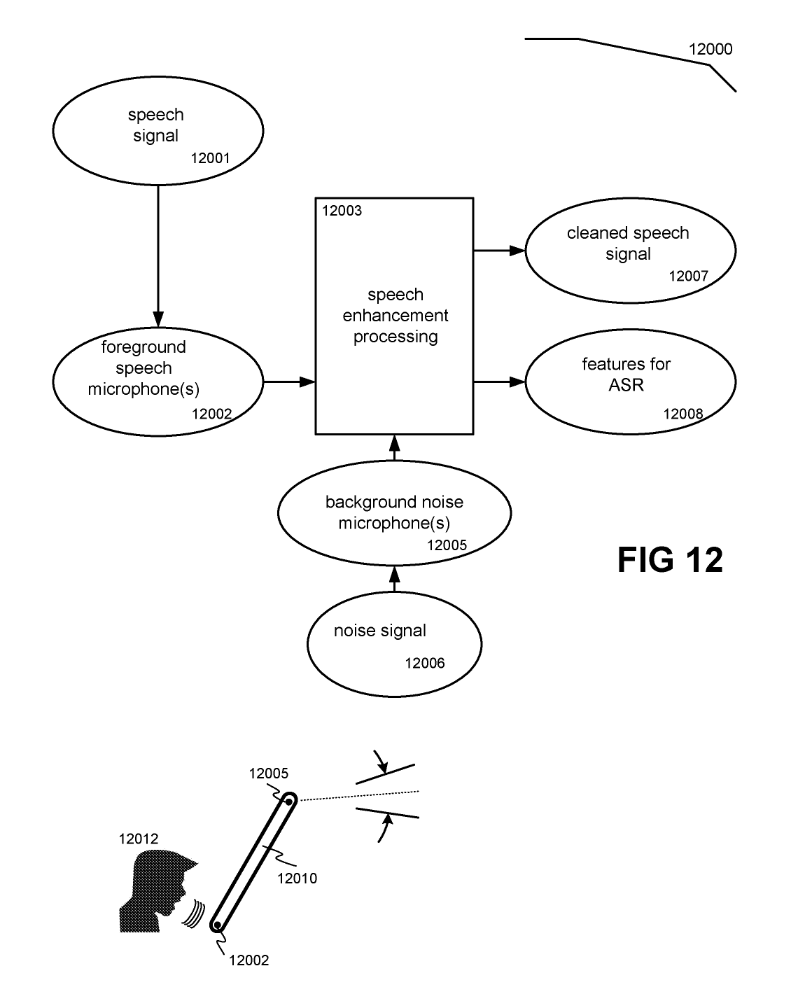

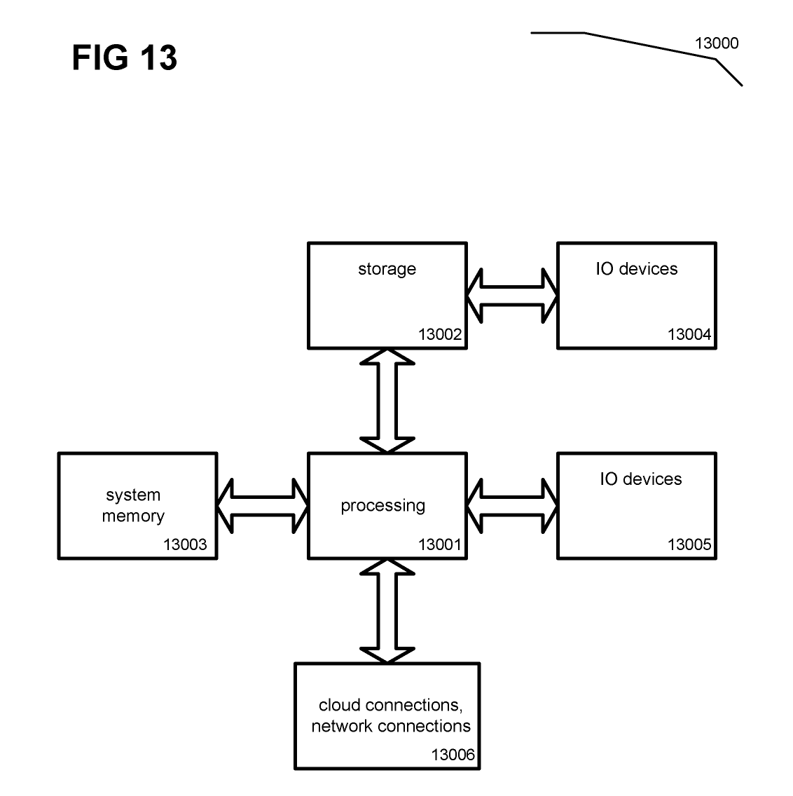

FIGS. 5A and 5B taken together depict embodiments of a microphone array and a beamforming function that can be employed alone and in combination. The embodiments shown in diagrams 5001 and 5501 can correspond to elements herein described and illustrated including mic array function 1030 and enhancement 1040 within diagram 1001, mic array function 2008 and enhancement proc 2009 within diagram 2001, beamforming function 4003 within diagram 4000, and foreground speech microphones 12002 and speech enhancement processing 12003 within diagram 12000.

Diagram 5001 depicts features of microphone array and beamforming embodiments. A room environment 5020 can contain a sound source such as a talker 5024. An apparatus 5030 can be tasked with acquiring a signal corresponding to the sound source, such as a speech signal. The apparatus 5030 can comprise one or microphones such as 5031 5032.

In some embodiments, a plurality of microphones can be disposed within an apparatus and/or the environment, and taken together can function as and be described as a microphone array. Signals corresponding to each microphone within the microphone array can be advantageously combined to provide enhanced spatial selectivity. Processing of the microphone signals to perform spatial filtering can separate signals that have overlapping frequency content but originate from different spatial locations. Such processing can be described as beam forming or beamforming. In some embodiments, microphones can be arranged in a physical geometry that enhances some spatial selectivity, such as in a phased array arrangement.

Spatial selectivity is illustrated as a microphone sensitivity pattern 5020 originating with position 5033. The pattern corresponds to a enhanced response within an arc angle 5041, essentially centered on an angle 5042 with respect to features of the apparatus 5030. Such selectivity can advantageously separate a desired sound source such as that provided by the depicted talker 5024, from undesired sound sources such as those at other angles to the apparatus. By way of example, the room environment 5020 can include undesired sources of noise, and, source and reflective/reverberant versions of sound program emitted by loudspeakers 5011 5012. In some embodiments, beamforming processing can advantageously provide spatial selectivity such as that depicted in diagram 5001.

Diagram 5501 depicts an embodiment of beamforming processing. Signals x₁ 5511, x₂ 5512, through xⱼ 5513, represent microphone signals respectively corresponding to an array of quantity j microphones. A processor 5510 can operate on the input signals to provide an output signal y 5521 that provides spatial selectivity over a relatively broad bandwidth. Many forms of such beamforming processing are known in the related arts. The specific example of a broadband beamformer depicted in 5521 is disclosed in: Barry D. Van Veen, Kevin M. Buckley. “Beamforming: A versatile approach to spatial filtering.” IEEE ASSP magazine, 1988: 4-24, the complete contents of which are hereby incorporated by reference. Additional embodiments of beamforming are disclosed in: Osamu HOSHUYAMA, Akihiko SUGIYAMA, and Akihiro HIRANO. “A Robust Adaptive Beamformer with a Blocking Matrix.” IEICE TRANS. FUNDAMENTALS E82-A, no. 4 (April 1999), the complete contents of which are hereby incorporated by reference.

Diagram 6000 depicts an embodiment of a transformation from time-domain amplitude signal to a frequency-band vector representation Such a transformation 6000 can correspond to transformation elements illustrated and described herein including 4005 and 4006. Input signal 6001 can correspond to a baseband speech signal s(t) such as illustrated and described herein as 4001 or 4002. Output signal X(t,m) 6008 can correspond to a frequency-band vector representation as illustrated and described herein as those provided by transformation elements 4005 and 4006.

s(t) can be a discrete-time representation of amplitude of a sample of a signal such as an audio signal corresponding to speech. Within framing function 6002, a sequence of frames can be determined. A frame comprises a specified quantity of samples. The elements of a frame can each be described as sᵢ(n) where i indexes the frame, n indexes the sample within the specified quantity of samples within the frame, and sᵢ(n) corresponds to a time t=tᵢ at which the input signal has value s(tᵢ).

A frame can correspond to overlapping spans of time domain samples. Such an overlap can be described by an overlap factor. The value of the overlap factor corresponds to the fraction of samples in a frame that are overlapped by a time-adjacent frame. By way of non-limiting example, an overlap factor of 0.5 indicates that each frame overlaps half of the time-domain samples in each adjacent frame. Various overlap values may be employed, as are suitable to the task.

Within function DFT 6003 the frames are transformed by Discrete Fourier Transform into a frequency-domain representation Si(k). The DFT output can be calculated as

Sᵢ(k)=Σₙ₌₁^{N}sᵢ(n)h(n)e^{-j2πkn/N} with 1≦k≦K

where: N is the number of samples within a frame; k indexes frequency bands 1 through K; and h(n) is an N sample long analysis window. In some embodiments the analysis window can be a Hanning window, a Hamming window, a Cosine window, and/or any other known and/or convenient window suitable to the framing function.

Within Estimate Power Spectra function 6004 a periodogram-based power spectral estimate Pᵢ(k) can be determined from the Sᵢ(k), corresponding to the sᵢ(n) frame and k^{th} frequency band, calculated as

$${P}_{i} ( k ) = \frac{1}{N} {\vert {S}_{i} ( k ) \vert}^{2}$$

Within Provide Mel Filter Banks function 6005, filter banks can be provided. As is well known in the art, a bank of filters linearly spaced on a transformed frequency scale can be provided. In some embodiments the transformed frequency scale can be the Mel scale. In other embodiments, the transformed frequency scale can be a Bark scale and/or any other known and/or convenient scale suitable to the function. In some typical embodiments, each filter of the filter bank can have a triangular response shape centered upon a linearly spaced frequency. In some other embodiments, each filter of the filter bank can have any other known and/or convenient response centered upon the frequency and suitable to the function.

Within Combine Power Spectra and Filter Banks function 6005, the power spectral estimates can be filtered by the filter banks to provide a measure of filter bank energies PMᵢ(m), where m indexes the filter banks from 1 to M. In some typical embodiments, there can be substantially fewer filter banks than DFT frequency bins. By way of non-limiting example, an embodiment may retain 257 of 512 DFT coefficients, but provide only 26 filters on the Mel scale.

Within Map Filter Bank Energies to log Filter Bank Energies function 6006, the energy measure of each filter PMᵢ(m) is mapped to the log of the measure, providing log filter bank energy measures PMLᵢ(m). Each PMLᵢ(m)=log(PMᵢ(m)). In some embodiments the log base can be 10.

The log filter bank energies can constitute a frequency-band vector representation X(t,m) output 6008 of the input signal s(n). X(t,m) can comprise an array of log filter bank energy measures. X(t,m) corresponds to PMLᵢ(m), for t=tᵢ. That is, for each time t=tᵢ there is a set of coefficients X(t,m₁) X(t,m₂) . . . X(t, mₘ) respectively corresponding to each m of the quantity M Mel frequency bands.

Diagram 7000 depicts an embodiment of an adaptive estimation filter. Such a filter can correspond to adaptive estimation filter function 4007 illustrated and described herein. Input 7001 comprises a frequency-domain signal X(t,m) that can correspond to the output of “transform: to frequency bands” function 4005. Input 7002 comprises a frequency-domain signal Y(t,m) that can correspond to the output of “transform: to frequency bands” function 4006. X(t,m) corresponds to a transformed microphone or microphone array signal, and Y(t,m) corresponds to a transformed media reference signal, in the herein described and illustrated embodiments.

A filter system embodiment 7000 employs a foreground adaptive filter 7003 and a fixed background filter 7004. The foreground adaptive filter 7003 can be implemented in a frequency domain, or other suitable signal space. In one embodiment, the foreground adaptive filter coefficients can be updated according to a Frequency Domain Adaptive (FDA) method. In another embodiment, a Fast Least Mean Square (FLMS) filter method can be employed. In yet another embodiment, a Fast Recursive Lease Squares (FRLS) filter method can be employed. Other suitable adaptive filters can comprise Fast Affine Projection (FAP) and Voterra filters.

Embodiments of Fast Recursive Least Squares filter methods are disclosed in: Farid Ykhlef, A. Guessoum and D. Berkani. “Fast Recursive Least Squares Algorithm for Acoustic Echo Cancellation Application.” “SETIT 2007; 4th International Conference: Sciences of Electronic, Technologies of Information and Telecommunications, 2007, the complete contents of which are hereby incorporated by reference. Embodiments of Fast Affine Projection are disclosed in: Steven L. Gay, Sanjeev Tavathia. “THE FAST AFFINE PROJECTION ALGORITHM.” ICAASP-95. 1995. 3023-3026, the complete contents of which are hereby incorporated by reference. Embodiments of Frequency Domain Adaptive filters are disclosed in: JIA-SIEN SOO, KNEE K. PANG. “Multidelay Block Frequency Domain Adaptive Filter.” IEEE TRANSACTIONS ON ACOUSTICS, SPEECH, AND SIGNAL PROCESSING 38, no. 2 (February 1990), the complete contents of which are hereby incorporated by reference.

The fixed background filter can be updated with recent settings of the foreground adaptive filter, if stability is determined. In step 7006, an estimated early reflection signal Yest can be obtained from the output of one of the filters 7003 7004, as determined by a filter control unit 7005. Filter control unit 7005 can select which filter to utilize, based on a residual value E. In step 7006, E can be evaluated as a difference between signal X, corresponding to microphone input, and Yest, corresponding to estimated early reflections of loudspeaker signal Y. The residual error result can be calculated as E=X-Yest. In some embodiments, E can be understood to represent ‘estimated speech.’ In a circumstance in which the fixed background filter output is selected, the adaptive foreground filter can be updated with the settings of the fixed background filter. In a circumstance that a near end user speech signal is present in microphone signal X, filter control unit 7005 can decrease the adaptation rate of the adaptive foreground filter, in order to minimize filter divergence.

The value of Yest obtained and the value of E calculated in step 7006 can be provided as outputs 7007 of the adaptive estimation filter function.

Diagram 8000 depicts an embodiment of a noise transformation process. This process corresponds to noise transformation function 4008, illustrated and described herein.

Noise transformation process 8000 receives inputs 8001 X(t,m), 8002 Y(t,m), 8003 Yest(t,m), and 8004 E(t,m). X(t,m) can be the frequency-transformed microphone signal provided by function 4005. Y(t,m) can be the frequency-transformed reference signal provided by function 4006. Yest(t,m) can be the estimated early reflections signal provided by adaptive estimation filter 4007 7000. E(t,m) can be an ‘estimated speech’ signal provided by adaptive estimation filter 4007 7000.

Noise transformation process 8000 provides output 8010 comprising speech probability measure Pspeech(t,m) and noise estimation N(t,m).

In an embodiment, the near end user speech signal can be absent from the microphone signal, thus the signal E(t, m) can largely comprise late reflections of the Y(t, m) signal. As the signal E(t, m) is highly correlated to Y(t, m), the signal Yest(t, m) can approach a true estimate of early reflections of Y(t, m).

Alternatively, the near end user speech can be present in the microphone signal, and E(t, m) can contain late reflections of Y(t, m) and near end user speech. Thus E(t, m) is less correlated to Y(t, m). Due to the nature of the adaptation processes employed in the estimation filtering unit 4007, Yest(t, m) can contain a mix of the early reflections estimation and a small portion of near end user speech signal.

A speech probability measure Pspeech(t, m) can indicate a relative amount of presence of near end user speech within Yest(t, m). Both Yest(t, m) and Pspeech(t, m) can be used in noise estimation function 8009 to derive an estimated noise N(t, m).

Within calculation function 8005 a set of energy and cross-correlation measures can be calculated. The measures Re(t), Rx(t), Ry(t) and Ryest(t) represent spectrum energy of E, X, Y and Yest at time t. Rex(t, m) is the cross correlation between E and X of the t^{th} frame and the m^{th} frequency band. Rey(t, m) is the cross correlation between E and Y of the t^{th} frame and the m^{th} frequency band.

Within calculation function 8006, an instant and/or short-time speech probability measure R(t,m) can be calculated. In an embodiment, the value of R is proportional to the value of Re and inversely proportional to Rey. The value of R is also inversely proportional to Ryest.

In an embodiment, R(t,m) can be responsive to a multiplication of several terms, and calculated as

R(t,m)=1/[(Rey(t,m)/Ry(t))*(Rex(t,m)/Rx(t))*(Ryest(t)/Re(t))]

In another embodiment, R(t,m) can be calculated recursively as

$$R ( t , m ) = {∝}_{r} * R ( t - 1 , m ) + \frac{( 1 - {∝}_{r} )}{[ \begin{matrix}( Rey ( t , m ) / Ry ( t ) ) * ( Rex ( t , m ) / Rx ( t ) ) * \\ ( Ryest ( t ) / ( Rx ( t ) - Ryest ( t ) ) )\end{matrix} ]}$$

where ∝ᵣ is a smoothing constant, 0<∝ᵣ<1.

With M as the total number of frequency bands for the following:

Re(t) is the spectrum energy of E for the t^{th} time slice (or frame)

$$Re ( t ) = \frac{{\sum }_{m = 0}^{M} ( {E ( t , m )}^{2} )}{M}$$

Rx(t) is the spectrum energy of X for the t^{th} time slice (or frame)

$$Rx ( t ) = \frac{{\sum }_{m = 0}^{M} ( {X ( t , m )}^{2} )}{M}$$

Ry(t) is the spectrum energy of Y for the t^{th} time slice (or frame)

$$Ry ( t ) = \frac{{\sum }_{m = 0}^{M} ( {Y ( t , m )}^{2} )}{M}$$

and Ryest(t) is the spectrum energy of Yest for the t^{th} time slice (or frame)

$$Ryest ( t ) = \frac{{\sum }_{m = 0}^{M} ( {Yest ( t , m )}^{2} )}{M}$$

Rex(t,m) can approximate cross correlation between E(t,m) and X(t,m) and can be calculated as

Rex=E*X^{T}

where E represents the matrix form of E(t,m), X represents the matrix form of X(t,m), and X^{T} is the transpose of X.

Rey(t,m) can approximate cross correlation between E(t,m) and Y(t,m) and can be calculated as

Rey=E*Y^{T}

where E represents the matrix form of E(t,m), Y represents the matrix form of Y(t,m), and Y^{T} is the transpose of Y.

In other embodiments, R(t, m) can be calculated using different equations depending on different values of Rx(t), Ry(t), Ryest(t) and different convergence states of the adaptive foreground filter 7003.

In some embodiments, within smoothing function 8007, the measures Re, Rx, Ry, Ryest, Rex and Rey can be smoothed by filtering across time frames and frequency bands before calculating the ratio R(t, m).

Pspeech(t, m) can be obtained 8008 by smoothing R(t, m) across several time frames and across several adjacent frequency bands. In one embodiment, a moving average filter can be used to achieve the smoothing effects. In an embodiment that applies a moving average filter to R(t,m), Pspeech can be calculated as

Pspeech(t,m)=[R(t−K,m)+R(t−K+1,m)+R(t−K+2,m)+ . . . +R(t−1,m)]/K

where K can be a constant, and can be chosen to be inversely proportional to the frame size of the short-time FFT (SFFT) that is used to transform the time-domain samples signal to the frequency domain.

By way of non-limiting example, under some conditions for a frame size of 10 msec., K can be 10, and, for a frame size of 5 msec., K can be 20.

Within the noise estimation calculation function 8009, noise estimation N(t, m) can be obtained as a weighted sum of the Yest(t, m) and a function of prior Yest values, which can be expressed as:

N(t,m)=((1−Pspeech(t,m))*Yest(t,m)+F[(1−Pspeech(t−i,j))*Yest(t−i,j)];

where i<t; 1<j<max number of bands, F[ ] is a function.

In one embodiment, F[ ] can be a weighted linear combination of the previous elements in Yest. Since the late reflections energy decays exponentially, the i term can be limited to frames within the first 100 milliseconds of a current frame. In one embodiment, the weight used in the linear combination can be the same across all previous elements in Yest. In another embodiment, the weight used in the linear combination can decrease exponentially, where the newer elements of Yest can receive larger weights than the older elements. In another embodiment, N(t, m) may be derived recursively as follows,

A(1,m)=P(1,m)*Yest(1,m);

B(1,m)=P(1,m)*Yest(1,m)−Yest(0,m);

A(t−1,m)=beta1*P(t−1,m)*Yest(t−1,m)+(1−beta1)*(A(t−2,m)−B(t−2,m));

B(t−1,m)=beta2*(A(t−1,m)−A(t−2,m))+(1−beta2)*B(t−2,m);

N(t,m)=P(t,m)*Yest(t,m)+P(t−1,m)*C_decay*(A(t−1,m)+B(t−1,m));

where P(t, m)=1−Pspeech(t, m);

beta1 is a constant, beta1 is within the range of 0.0 to 1.0;

beta2 is a constant, beta2 is within the range of 0.0 to 1.0; and,

C_decay is a constant, and C_decay is within the range of 0.0 to 1.0.

Diagram 9000 depicts an embodiment of a noise reduction function, such as illustrated and described herein as “noise reduction” function 4011 in diagram 4000. Input 9001 comprises a speech probability Pspeech(t,m) signal that can correspond to and be provided as an output of noise transformation function 4008 8000. Input 9002 comprises a noise reference N(t,m) signal that can correspond to and be provided as an output of noise transformation function 4008 8000. Input 9003 comprises ‘estimated speech’ E signal that can correspond to and be provided as an output of adaptive estimation filter 4007 7000. Output 9008 comprises a cleaned speech S(t,m) signal.

The noise reduction function can employ estimated noise N(t, m) and speech probability Pspeech(t, m) signals to further suppress noise components in signal E. Noise signal N can closely represent noise components in E, so N can be employed effectively as a true reference for embodiments of noise reduction/suppression for signal E. An example noise reduction procedure for generating cleaned speech signal S can be described:

Step 9004 depicts calculating an “a posteriori SNR,” post(t, m),

post(t,m)=power[E(t,m)]/Var_{N}(t,m)

where Var_{N} is the variance of N(t, m), and power[E(t, m)] is the power of the E(t, m) signal. Power of a signal can be evaluated as sum of the absolute squares of its samples divided by the signal sample length, or, equivalently, the square of the signal's RMS level.

Step 9005 depicts calculating an “a priori SNR,” prior(t,m),

prior(t,m)=a*S(t−1,m)/Var_{N}(t−1,m)+(1−a)*P[post(t,m)−1]

where a is a smoothing constant, 0<a<1, and

P[ ] is an operator: if x>=0, P[x]=x; if x<0, P[x]=0;

Step 9006 depicts calculating a noise reduction gain G(t, m). A ratio U(t, m) can be calculated as

U(t,m)=prior(t,m)*post(t,m)/(1+prior(t,m))

A Minimum Mean Squared Error(MMSE) estimator gain, Gm(t, m), can be calculated as

Gm(t,m)=(sqrt(n)/2)*(sqrt(U(t,m)*post(t,m))*exp(−U(t,m)/2)*((1+U(t,m))*I0[U(t,m)/2)]+U(t,m)*I1[U(t,m)/2])

where sqrt( ) is a square root operator, exp( ) is an exponential function, I0[ ] is the zero order modified Bessel function, and I1[ ] is the first order modified Bessel function.

Thus, a noise reduction gain G(t, m) employing U(t,m) and Gm(t,m) can be calculated as

G(t,m)=[Pspeech(t,m)*Gm(t,m)]+[(1−Pspeech(t,m))*Gmin]

where Gmin is a constant, 0<Gmin<1.

Step 9007 depicts obtaining cleaned speech signal S(t,m). S(t,m) can be calculated by applying noise reduction gain G(t, m) to E(t, m), as

S(t,m)=G(t,m)*E(t,m)

In alternative embodiments, a variety of techniques can be applied to determining an estimator gain Gm(t,m) that can be employed to determine the noise reduction gain G(t,m). A Wiener filter, a Log-Spectral Amplitude (LSA) estimator, or an Optimal Modified LSA (OM-LSA) estimator, can be employed to provide Gm(t,m).

Embodiments of a Wiener filter are disclosed in: Wikipedia. Wiener Filter. Jul. 3, 2012. en.wikipedia.org/w/index.php?title=Wiener_filter (accessed Feb. 7, 2016), the complete contents of which are hereby incorporated by reference Embodiments of an LSA estimator are disclosed in: Yariv Ephraim, David Malah. “Speech Enhancement Using a Minimum Mean-Square Error Log-Spectral Amplitude Estimator” IEEE TRANSACTIONS ON ACOUSTICS, SPEECH, AND SIGNAL PROCESSING ASSP-33, no. 2 (March 1985), the complete contents of which are hereby incorporated by reference. Further embodiments of estimators are disclosed in: Yariv Ephraim, David Malah. “Speech Enhancement Using a Minimum Mean-Square Error Short-Time Spectral Amplitude Estimator” IEEE TRANSACTIONS ON ACOUSTICS, SPEECH, AND SIGNAL PROCESSING ASSP-32, no. 6 (December 1984), the complete contents of which are hereby incorporated by reference.

Diagram 10000 depicts an embodiment of a formant emphasis filter. Such a filter can correspond to formant filter 4015 illustrated and described herein, notably within diagram 4000. Input 10001 comprises speech probability signal Pspeech(t,m) that can correspond to and be provided as an output of noise transformation function 4008 8000.

Input 10008 comprises cleaned speech signal S(t,m) that can correspond to an output of “noise reduction” function 4011 9000.

In step 10002, average speech probability Avg_Pspeech(t) for a t^{th} frame can be calculated from speech probability Pspeech(t, m). Avg_Pspeech(t) can be determined from a weighted and appropriately scaled sum of Pspeech(t, m) across all frequency bands. In one embodiment, Pspeech(t,m) across all frequency bands can be weighted equally. In another embodiment, Pspeech(t,m) corresponding to speech bands within a specified range can be weighted relatively more than bands outside the range. By way of non-limiting example, such a specified range can comprise 300 Hz to 4000 Hz.

In step 10003, Avg_Pspeech(t) can be compared to a specified threshold T. In some embodiments, the value of T can be 0.5. In other embodiments, the value of T can vary.

In step 10004, control flow responds to the result of the comparison in step 10003. If the comparison shows Avg_Pspeech(t) to be greater than the threshold, flow follows path 10005. Otherwise, flow follows path 10006.

Step 10007 depicts cases in which Avg_Pspeech(t) does not meet the threshold comparison of step 10003. This can indicate that the t^{th} frame of speech S(t,m) is likely to be a non-speech frame. Thus formant emphasis can be inappropriate for that frame. In response, formant emphasis is not applied to the t^{th} frame of S(t,m).

In step 10009, cepstral coefficients for the cleaned speech S(t, m) can be calculated. Cepstral coefficients Cepst(t, m) can be derived by Discrete Cosine Transform (DCT). In some embodiments, a subset of the DCT result coefficients are retained to represent the signal as Cepst(t,m). In an embodiment wherein S(t,m) is a result of time-to-frequency transformations utilizing the Mel frequency scale, the Cepst(t,m) can be described as Mel frequency cepstral coefficients (MFCC). In an embodiment wherein S(t,m) is a result of such transformations utilizing the Bark frequency scale, the Cepst(t,m) can be described as Bark frequency cepstral coefficients (BFCC). Some such embodiments of time-to-frequency transformations are herein described and illustrated as and within “transform to frequency bands” 4005 4006 6000.

A variety of embodiments for providing MFCCs are disclosed in: Fang Zheng, Guoliang Zhang, and Zhanjiang Song. “COMPARISON OF DIFFERENT IMPLEMENTATIONS OF MFCC.” J. Computer Science & Technology, 16(6): 582-589, Sep. 2001 16, no. 6 (September 2001): 582-589, the complete contents of which are hereby incorporated by reference.

Control path 10005 is taken in cases in which Avg_Pspeech(t) meets the threshold comparison of step 10003. This can indicate that the t^{th} frame of speech S(t,m) is likely to be a speech frame. Thus emphasis can appropriately be applied to the t^{th} speech frame.

In step 10010, an emphasis gain matrix G_formant can be determined. In one embodiment, G_formant(t, m) can be calculated as

G_formant(t,m)=Kconst*Pspeech(t,m)/Pspeech_max(t);

where Kconst is a constant, Kconst>1.0, and Pspeech_max(t) is the maximum value of Pspeech(t,m) at a specified time t, across the frequency bands. Thus, in an embodiment, the gain of the formant emphasis filter can be responsive to Pspeech(t,m).

Step 10011 depicts applying an emphasis gain matrix G_formant to cleaned speech signal S. Coefficients Cepst′(t,m) can be developed by multiplying Cepst(t,m) by gain matrix G_formant:

Cepst′=Cepst*G_formant.

That is, across a set of values oft and m, for each (t,m),

Cepst′(t,m)=Cepst(t,m)*G_formant(t,m).

Notably, gain value elements of G_formant are proportional to corresponding values of Pspeech(t, m). The cepstral coefficients of Cepst′ can represent an emphasized version of the cleaned speech signal.

In one embodiment, the gain G_formant(t, m) can be applied to only a portion of the cepstral coefficients in forming Cepst′. Zero order and first order cepstral coefficients can remain unaltered, in order to preserve a spectrum tilt. Cepstral Coefficients beyond the 30^{th} order can also remain unaltered, as such coefficients can be understood not to significantly change a formant spectrum shape.

In step 10012, gain-emphasized cepstral coefficients Cepst′(t,m) can be transformed to a frequency domain signal SE(t,m) through application of an Inverse Discrete Cosine Transform (IDCT). In an embodiment, the spectrum of SE(t, m) can have higher formant peaks and lower formant valleys than does the unemphasized signal S(t,m). In some embodiments, the higher formant peaks and lower formant valleys can improve recognition rate performance of an Automatic Speech Recognizer (ASR).

Output 10003 can comprise the selectively emphasized frequency-domain signal SE(t,m).

Diagram 11000 depicts an embodiment of performance enhancements for an automatic speech recognizer. ASR 11010 can correspond to elements illustrated and described herein including ASR 1050, ASR 2011, and ASR 4019. Inputs 11001 can comprise one or more of several signals comprising: a baseband speech signal s(t) such as provided by transform 4021 that can be a time-domain amplitude signal; a speech signal SE(t,m) such as provided by formant emphasis filter 4015 10000 that can be a frequency-band vector representation; and, a speech probability signal Pspeech(t,m) such as provided by noise transformation 8000.

Voice activity detection can be provided by a Voice Activity Detector VAD 11012. A feature extraction function 11013 can be responsive to inputs 11001 and provide specific measures to a decision function 11014. In response, the decision function 11014 can provide a time-varying signal indicative of voice activity, such as present(t) 11015. Such a present(t) signal can be advantageously employed by other ASR processing 11011 to provide ASR outputs 11016 such as recognized words.

In some prior art embodiments, voice activity detection systems and/or methods employ speech signal features such as short term energy and/or zero crossing rate to determine speech presence or absence. In the presence of noise, those features can inaccurately represent statistical characteristics of speech, resulting in inaccurate determinations of presence or absence. Thus there is a need to provide voice activity detection with improved performance.

Signals SE(t,m) and Pspeech(t,m) as herein described can be employed to increase accuracy of a Voice Activity Detector such as VAD 11012.

Within feature extraction function 11013 a spectral flatness feature STM(t) can be obtained from S(t,m), and an averaged speech probability feature Avg_Pspeech(t) can be obtained from Pspeech(t,m). These features can be provided to decision function 11014. Within decision function 11014, a decision can be determined responsive to a weighted combination of the features.

Spectral flatness can provide a measure of the uniformity, width, and noisiness of a spectrum. A high STM( ) can indicate similar amounts of power across all spectral bands in a spectrum; such a spectrum can be described as relatively flat and smooth. A low STM( ) can indicate relatively less uniformity across the bands, and can be described as having relatively more valleys and peaks. White noise can have a relatively flat and smooth spectral appearance. Speech signals typically possess relatively more variation. Spectral flatness STM can be defined as a ratio between the arithmetic mean of a power spectrum (AM) and a geometric mean of that power spectrum (GM). A mathematical constraint is that GM must be less than or equal to AM. The spectral flatness measure can be determined on a log scale and represented as LSTM(t). A log scale can be employed to correspond to psychoacoustic characteristics of human hearing.

LSTM(t) can be calculated as:

$$LSTM ( t ) = {\sum }_{m = 0}^{M - 1} {log}_{10} \frac{GM ( t , m )}{AM ( t , m )}$$

where M is the total number of bands.

GM(t,m) is the K^{th} root of the product of the last K frames of S(t,m). In some embodiments, K can have a value of 10. GM(t,m) can be expressed as

$$\begin{matrix}GM ( t , m ) = \sqrt[K]{{\prod }_{t - K + 1}^{t} S ( t , m )} \\ = \sqrt[K]{\begin{matrix}S ( t - K + 1 , m ) * S ( t - K + 2 , m ) * \\ S ( t - K + 3 , m ) * … * S ( t - 1 , m )\end{matrix}}\end{matrix}$$

AM(t,m) can be evaluated as a summation of the last K frames of S(t,m), then divided by K

$$AM ( t , m ) = \frac{1}{K} [ S ( t - K + 1 , m ) * S ( t - K + 2 , m ) * S ( t - K + 3 , m ) * … * S ( t - 1 , m ) ]$$

Avg_Pspeech(t) can be calculated as an average of input Pspeech(t,m) across frequency bands (indexed by m) for a frame corresponding to time t. Such a calculation is herein illustrated and described corresponding to diagram 10000 and element 10002.

An indication of speech activity for a t^{th} frame can be calculated as a weighted combination of Avg_Pspeech(t) and LSTM(t). In some embodiments, the two features can be weighted equally as 0.5. The weighted combination can be tested against a threshold to provide a binary valued output. In some embodiments, the decision threshold can be set to 0.5. Example calculations can be expressed:

if [0.5*Avg_Pspeech(t)+0.5*LSTM(t)]>=threshold, speech is present

if [0.5*Avg_Pspeech(t)+0.5*LSTM(t)]<threshold, speech is not present

In some embodiments, speech presence corresponding to time t can be indicated by signal present(t) 11015 that takes on a TRUE or FALSE value corresponding to the result of the calculation.

In alternative embodiments, within feature extraction function 11013 other speech features can be extracted from S(t,m). These additional features can comprise one or more of MFCC, Delta MFCC, and/or spectrum energy. In combination with spectral flatness and speech probability features, these features can constitute a multi-dimensional features set. Within the decision function 11014, several classifiers can be employed to determine a decision in combination with the multi-dimensional features set. Such classifiers can comprise one or more of Support Vector Machines (SVMs), Gaussian Mixtures of Models (GMMs), Artificial Neural Networks (ANNs), Decision Trees (DTs), and Random Forests (RFs).

Diagram 12000 depicts an exemplary mobile phone application embodiment. On a telephone device 12010, one or more microphones and/or a microphone array can be disposed on the phone proximate to, and have maximum sensitivity essentially aligned in the direction of, a talking user, that is, a talker 12012. Such a microphone or microphones can be designated as foreground speech microphone(s) 12002. One or more additional microphones and/or a microphone array can be described as background noise microphone(s) 12005. Background noise microphone(s) 12005 can be disposed at an opposite, distal, end of a device from the foreground speech microphone(s) 12002. The background noise microphone(s) 12005 can be pointed away from a talker.

A signal received at foreground speech microphone(s) 12002 can principally comprise a speech signal 12001 combined with background noise. A signal received at background noise microphone 12005 signal can principally comprise a background noise signal 12006. The background noise signal 12006 can serve as a media reference signal 4002 as described and illustrated herein. Speech enhancement processing 12003 can be employed to remove background noise from the foreground speech microphone signal. Details of such enhancement processing are described and illustrated in diagram 4000 and related drawings herein.

In this 12000 embodiment, an early reflections signal Yest provided by an adaptive estimation filter 4007 7000 can represent early arrival sounds at the location of the background noise microphone(s) 12005 with respect to the location of foreground speech microphone(s) 12002. Thus, the early reflections signal Yest can represent an estimated direct acoustic propagation path between distal and proximal microphone locations on the phone. The processing steps described and illustrated in diagram 4000 herein are applicable. A cleaned speech output signal 12007 can thus be provided. In some application embodiments, the cleaned speech signal 12007 can be coded and transmitted to another user. In some embodiments, user speech can be characterized by one or more sets of processing profiles and/or acoustic features such as MFCC and PLP, which can be generated by speech enhancement processing 12003. In some embodiments, such profiles and/or features, depicted as ‘features for ASR’ 12008 can be suitable to be employed in operations of an ASR engine 4019 11010. In some embodiments, such profiles and/or features can be employed alone and/or in combination for pattern matching with respect to an acoustic model database.

The execution of the sequences of instructions required to practice the embodiments may be performed by a computer system as shown in diagram 13000. Diagram 13000 illustrates an example of a general computing system environment. The computing system environment serves as an example, and is not intended to suggest any limitation to the scope of use or functionality of the embodiments herein disclosed. The computing environment should not be interpreted as having any dependency or requirement relating to any one or combination of components illustrated in the exemplary operating environment. The illustrated system 13000 can comprise a processing unit 13001, a storage unit 13002, a memory unit 13003, several input and output devices 13004 and 13005, and cloud/network connections 13006. The processing unit 13001 can be a Central Processing Unit, Digital Signal Processor, Graphical Processing Unit, a computer, and/or any other known and/or convenient processor. It can be single core or multi core. The system memory unit 13003 can be volatile (such as RAM), non-volatile (such as ROM, flash memory, etc.) or some combination of the two. The storage unit 13002 can be removable and/or non-removable, such as magnetic or optical disks or tape. Both memory 13003 and storage 13002 can be storage media wherein computer readable instructions, data structures, program modules or other data can be stored. Both memory 13003 and storage 13002 can be computer readable media. Other storage can also be employed by the system to carry out the embodiments. Such storage can include, but is not limited to RAM, ROM, EEPROM, flash memory and/or other memory technology, CD-ROM, digital versatile disks (DVD), and/or other magnetic storage devices and/or any other medium which can be used to store the desired information and which can be accessed by device 13000. I/O devices 13004 and 13005 can be microphone or microphone arrays, speakers, keyboard, mouse, camera, pen, voice input device and/or any other known and/or convenient I/O devices. Computer readable instructions and/or input/output signals can be transported to and from network connection 13006. Such a network can be optical, wired, and/or wireless. Computer programs implemented according to the disclosed embodiments can be executed in a distributed computing configuration, by remote processing devices connected through a network. Such computer programs can comprise routines, objects, components, data structures, classes, methods, and/or any other known and/or convenient organization.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

Some operations are described herein as occurring within and/or performed by elements depicted in the diagrams and identified variously as: steps, functions, blocks, processes, filters, and/or processors. Notably, such descriptions of the illustrated elements are meant to be illustrative and not limiting. That is, by way of example, an operation identified as performed within a step can also be embodied and/or performed within and/or by a function, block, process, filter, and/or processor.

Notably, methods are described herein comprising steps that are listed in a particular order. It can be appreciated that variations can be made in the order of practicing the steps without departing from the broader spirit and scope of the embodiments. In general, such steps are presented without limitation to the order in which they can be practiced, unless a specific requirement for order is presented. The scope of such embodiments is not limited to those that practice each and/or every step described.

1. A system comprising:
an adaptive estimation filter configured to
receive a processed microphone signal,
receive a processed media reference signal,
provide an estimated early reflections signal responsive to the processed microphone signal and the processed media reference signal, and,
provide an estimated speech signal responsive to the processed microphone signal and the estimated early reflections signal;
a noise transformation function communicatively coupled with the adaptive estimation filter and configured to
provide a speech probability measure responsive to the processed microphone signal, the processed media reference signal, the estimated early reflections signal, and the estimated speech signal, and,
provide a noise estimation responsive to the estimated early reflections signal and the estimated speech signal;
a noise reduction function communicatively coupled with the noise transformation function and configured to provide a first cleaned speech signal responsive to the speech probability measure, the noise estimation, and the estimated speech signal;
a formant emphasis filter communicatively coupled with the noise reduction function and configured to provide an emphasized speech spectrum responsive to the speech probability measure and the first cleaned speech signal;
an automatic speech recognizer communicatively coupled with the formant emphasis filter and configured to provide recognized words responsive to the speech probability measure and the emphasized speech spectrum; and,
a media device communicatively coupled with the automatic speech recognizer and configured to
provide a media reference signal, and,
control media device functions responsive to the recognized words;
wherein the processed media reference signal is responsive to the media reference signal.

2. The system of claim 1:
wherein the media device is configured to provide an acoustically coupled loudspeaker signal corresponding to the media reference signal; and,
wherein the processed microphone signal is responsive to the acoustically coupled loudspeaker signal and a user speech signal.

3. The system of claim 1 further comprising:
a microphone array configured to provide a plurality of microphone signals; and,
a beamforming function communicatively coupled with the microphone array and configured to provide a spatially selective microphone signal responsive to the plurality of microphone signals;
wherein the processed microphone signal is responsive to the spatially selective microphone signal.

4. The system of claim 3:
wherein the beamforming function is according to one of a minimum variance distortionless response beamforming technique or a linearly constrained minimum variance beamforming technique.

5. The system of claim 3 further comprising:
an analysis transformation function communicatively coupled with the beamforming function and configured to provide the processed microphone signal responsive to the spatially selective microphone signal;
wherein the processed microphone signal is provided in a frequency-domain representation.

6. The system of claim 1 further comprising:
a channel de-correlation function communicatively coupled with the media device and configured to provide a channel de-correlated media reference signal responsive to the media reference signal; and,
an analysis transformation function communicatively coupled with the channel de-correlation function and configured to provide the processed media reference signal responsive to the channel de-correlated media reference signal;
wherein the processed media reference signal is provided in a frequency-domain representation.

7. The system of claim 1:
wherein the media device comprises a background noise microphone;
wherein the background noise microphone is configured to provide a background noise signal; and,
wherein the media reference signal corresponds to the background noise signal.

8. The system of claim 1 further comprising:
a spectrum band reconstruction function communicatively coupled with the noise reduction function and configured to provide reconstructed lower frequency bands responsive to the first cleaned speech signal; and,
a synthesis transformation function communicatively coupled with the spectrum band reconstruction function and configured to provide a time domain cleaned speech signal responsive to the first cleaned speech signal and the reconstructed lower frequency bands.

9. The system of claim 1 further comprising:
a voice activity detector communicatively coupled with the automatic speech recognizer and configured to provide a spectral flatness measure, an average speech probability, and a speech activity indicator;
wherein the spectral flatness measure is responsive to the emphasized speech spectrum;
wherein the average speech probability is responsive to the speech probability measure;
wherein the speech activity indicator is responsive to the spectral flatness measure and the average speech probability; and,
wherein the automatic speech recognizer provides recognized words further responsive to the speech activity indicator.

10. The system of claim 1 further comprising:
a feature extraction function communicatively coupled with the formant emphasis filter and configured to extract acoustic features from the emphasized speech spectrum; and,
a processing profile function communicatively coupled with the formant emphasis filter and configured to develop a processing profile from the emphasized speech spectrum;
wherein the automatic speech recognizer is configured to provide the recognized words further responsive to the acoustic features and the processing profile.

11. The system of claim 1:
wherein the adaptive estimation filter comprises a foreground filter and a background filter;
wherein the foreground filter has a length corresponding to not more than 80 milliseconds; and,
wherein the background filter has a length corresponding to not more than 80 milliseconds.

12. A method comprising the steps of:
adaptive estimation filtering a processed microphone signal and a processed media reference signal, thereby providing an estimated early reflections signal and an estimated speech signal;
providing a speech probability measure responsive to the processed microphone signal, the processed media reference signal, the estimated early reflections signal, and the estimated speech signal;
estimating noise responsive to the estimated early reflections signal and the estimated speech signal, thereby providing a noise estimation;
providing a first cleaned speech signal responsive to the speech probability measure, the noise estimation, and the estimated speech signal;
formant emphasis filtering the first cleaned speech signal responsive to the speech probability measure, thereby providing an emphasized speech spectrum;
recognizing words responsive to the speech probability measure and the emphasized speech spectrum, thereby providing recognized words;
providing a media device having media device functions;
the media device providing a media reference signal; and,
controlling media device functions responsive to the recognized words;
wherein the processed media reference signal is responsive to the media reference signal.

13. The method of claim 12 further comprising the step of:
providing an acoustically coupled loudspeaker signal corresponding to the media reference signal;
wherein the processed microphone signal is responsive to the acoustically coupled loudspeaker signal and a user speech signal.

14. The method of claim 12 further comprising the steps of:
providing a microphone array;
the microphone array providing a plurality of microphone signals; and, beamforming the plurality of microphone signals, thereby providing a spatially selective microphone signal;
wherein the processed microphone signal is responsive to the spatially selective microphone signal.

15. The method of claim 14:
wherein beamforming is according to one of a minimum variance distortionless response beamforming technique or a linearly constrained minimum variance beamforming technique.

16. The method of claim 14 further comprising the step of:
transforming the spatially selective microphone signal to a frequency-domain representation, thereby providing the processed microphone signal.

17. The method of claim 12 further comprising the steps of:
de-correlating the media reference signal, thereby providing a channel de-correlated media reference signal; and,
transforming the channel de-correlated media reference signal to a frequency-domain representation, thereby providing the processed media reference signal.

18. The method of claim 12:
wherein the media device comprises a background noise microphone;
the background noise microphone providing a background noise signal; and,
wherein the media reference signal corresponds to the background noise signal.

19. The method of claim 12 further comprising the steps of:
reconstructing spectrum bands of the first cleaned speech signal, thereby providing reconstructed lower frequency bands; and,
transforming the first cleaned speech signal and the reconstructed lower frequency bands to a time-domain cleaned speech signal.

20. The method of claim 12 further comprising the steps of:
providing a spectral flatness measure responsive to the emphasized speech spectrum;
providing an average speech probability responsive to the speech probability measure;
providing a speech activity indicator responsive to the spectral flatness measure and the average speech probability; and,
recognizing words further responsive to the speech activity indicator.

21. The method of claim 12 further comprising the steps of:
extracting acoustic features from the emphasized speech spectrum;
developing a processing profile from the emphasized speech spectrum; and,
recognizing words further responsive to the acoustic features and the processing profile.

22. The method of claim 12 further comprising the step of:
providing an adaptive estimation filter configured to perform adaptive estimation filtering;
wherein the adaptive estimation filter comprises a foreground filter and a background filter;
wherein the foreground filter has a length corresponding to not more than 80 milliseconds; and,
wherein the background filter has a length corresponding to not more than 80 milliseconds.
